(19) United States
(12) Patent Application Publication
(10) Pub. No.: US 2012/0096673 A1
(43) Pub. Date: Apr. 26, 2012

(54) Entrapped or Entrapping Laterally Movable Grommet

(76) Inventor: Dale Jared Retter, Scottsdale, AZ (US)

(21) Appl. No.: 12/912,708

(22) Filed: Oct. 26, 2010

(51) Int. Cl. F16L 5/10

(52) U.S. Cl. 16/2.2

(57) ABSTRACT

A grommet like device including at least three layers that can be attached to a larger flat surface to allow a cable or other object to move perpendicularly through a hole in a movable fee floating layer of this grommet like device, such that the cable or moving object can displace a freely movable portion of the grommet further in a direction largely parallel to the surface to which the grommet is attached, than a small opening or attachment in the center of the grommet, would otherwise allow without causing a lateral movement of the larger surface, substantial pressure or friction, or a larger unobstructed opening in the larger flat surface.

### REFERENCES CITED [REFERENCED BY]

### U.S. Patent Documents

| Patent | Date | Inventor |
|---|---|---|
| 2,354,919 | August 1944 | Lockwood |
| 2,417,260 | March 1947 | Morehouse |
| 3,397,431 | August 1968 | Walker |
| 3,414,220 | December 1968 | Walker |
| 3,695,563 | October 1972 | Evans |
| 3,742,119P | June 1973 | Newman |
| 4,199,070 | April 1980 | Magnussen, Jr. |
| 5,098,047 | March 1992 | Plumley |
| 5,205,520 | April 1993 | Walker |
| 5,707,169 | January 1998 | Schweighofer et al. |
| 5,992,802 | November 1999 | Campbell |
| 5,996,945 | December 1999 | Coles et al. |
| 6,002,088 | December 1999 | Ehmann |
| 7,723,622 B2 | May 25, 2010 | Dukes et al. |
| 7,806,374 | Oct. 5, 2010 | Ehmann, et al. |

### FOREIGN PATENT DOCUMENTS

| Patent Number | Date | Country |
|---|---|---|
| 40 20 180 | July 1991 | DE |
| 4434202 | September 1995 | DE |
| 4441478 | May 1996 | DE |
| 19547214 | February 1997 | DE |
| 197 21 659 | November 1998 | DE |
| 19852133 | May 2000 | DE |
| 0778436 | June 1997 | EP |
| 794354 | September 1997 | EP |
| WO 99/06747 | February 1999 | WO |

### FIELD OF THE INVENTION

The present invention relates to a physical mechanical construction of a grommet like device that can be attached to a larger flat surface for the purposes of allowing a cable or structure to move perpendicularly to the flat surface by passing through an opening just large enough to allow this movement and by laterally displacing a provided movable section of the assembly through which it passes that is not rigidly affixed to the larger flat surface achieve unimpeded lateral motion or allow a cable or object attached to the moveable portion of this grommet to achieve such unimpeded lateral movement. This device may be used to in applications where a larger flat barrier to flow of gas, liquid, or energy is desired and there is a need to have a cable, wire, tube, or other freely moving structure pass through the larger barrier without causing displacement of the larger flat barrier and without causing high levels of stress or friction. Some examples of such systems are cables requiring lateral movement passing through a flat sheet or tarp intended to provide shelter from rain, a movable cable that passes through a duct use to conduct liquid or fluid, a movable cable that passes through an enclosure that is intended to contain a radio frequency signal, or acoustical sound such that the cable may be moved freely without requiring a large opening in the enclosure.

### BACKGROUND

It is a well know and long standing practice to make a hole in a cloth, tarp, or flat sheet of material and attach a grommet to the material surrounding the hole for purposes of mechanically reinforcing the hole and the material immediately surrounding it to withstand forces applied non perpendicularly to the martial by the cable, without further expanding the central hole or causing additionally tearing of the flat surface if a cable, cord or other moving object is passed through the hole, and/or for purposes of reducing the friction and/or abrasion caused by the cord, cable, or moving object passing through the hole. Note: if the cable, cord or moving object moves substantially perpendicularly to the flat surface the existing hole and grommet does not general impede the movement of the cable unless the cable is knotted, looped or otherwise has a diameter larger than the grommet through which it otherwise may pass. For example, a cloth tarpaulin may have metal grommets attached to the tarpaulin at various points. Subsequently a person desiring to suspend the tarp in a particular location, perhaps to provide protection from rain, could pass a cable or cord through the hole in the grommets and then use the cord or a loop of cord to hold that part of the tarpaulins in the desired location. The Grommet being stronger and less vulnerable to tearing allows the cable to transfer forces to the flat sheet or tarpaulin in various directions with an increased resistance, increased pressures on the flat sheet of material, while providing a decrease in the likelihood of a tear or rip in the material.

If lateral movement of the cable passing through or fastened to the grommet is not required existing art provides an adequate solution. If lateral movement of the cable relative to the primarily flat surface is required, one existing solution is to increase the diameter of the hole in the center of the grommet to allow a larger opening within which the cable can move in directions relatively parallel to the flat surface. However this solution requires what may be an. undesirably larger open gap between the cable and the hole it passes through leaving a large open gap which can interfere with successfully using the sheet to create a barrier to the flow of fluid, gas, or energy (such as light or microwave), or partials such as dust or sand, from one side of the sheet to the other. Such a gap allows material, such as gas, or fluid to travel from one side of the tarpaulin or sheet material to the other side by passing freely through this enlarged gap. Since tarpaulins or sheets of flat material are often used to create a barrier to such undesired flow (for example to the flow of water when used as a rain or splash barrier) enlarging the hole in the material can cause an undesirable leakage trough this hole. Likewise if the center of the opening in a fixed grommet is not in ideal alignment with the location of cable or object intended to pass through it or be anchored to it, movement of the Free Floating Gasket will allow it to move in order to accommodate an otherwise imperfect alignment without enlarging the open hole in the grommet

The Entrapped or Entrapping Laterally Movable Grommet solves the aforementioned problem in a meaner not previously available under the existing art. Specifically this invention allows the cable or the flat surface through which it is passing to move in a direction largely perpendicular to the flat surface, with reduced strain, friction and cross pressure between the cable or moving object and the Entrapped or Entrapping Laterally Movable Grommet and the larger surface that it is attached to. The purpose of this invention is to provide new unique solution to the previously mentioned problem, whereby a Entrapped or Entrapping Laterally Movable Grommet may be created and attached either within an enclosure created as a part of this Entrapped or Entrapping Laterally Movable Grommet System, or whereby the Entrapped or Entrapping Laterally Movable Grommet creates an enclosure entrapping a portion of the grater flat surface of material to which it is attached, such that, the Entrapped or Entrapping Laterally Movable Grommet can move, in a direction largely perpendicular relative to the sheet of material through which the cable or moving object may travel, or to which it may be anchored, such that perpendicular motion with reduced side pressures or friction is permitted within an a range of motion larger than the smaller hole in the gasket.

### SUMMARY OF THE INVENTION

### Specifications

It is an object of this invention to provide an new and improved form of grommet that allows for a cable, cord or moving object to pass freely through a hole in the central portion of a Entrapped or Entrapping Laterally Movable Grommet that includes an opening the same size or slightly larger than a cross sectional area a cable, cord, or moving object passing through or attached to it at an anchor point, in a direction largely perpendicular to the largely flat surface to which it is attached, such that either:
an Entrapped or Entrapping Laterally Movable Grommet with a central opening, or anchoring point for attachment at a central point to which a cable may be affixed, is entrapped in a created enclosure within which it can move in directions largely parallel to the surface to which it is attached;
or the Entrapped or Entrapping Laterally Movable Grommet has at least two layers and creates between them a region of entrapment that can contain a hole and material surrounding the hole such that the material trapped within this Entrapped or Entrapping Laterally Movable Grommet assembly both supports and limits the motion of the Entrapped or Entrapping Laterally Movable Grommet; such that both embodiments of the Entrapped or Entrapping Laterally Movable Grommet permit an increased range of lateral motion, which is grater than the hole in the center of the floating grommet would permit, or if a cable is affixed to a central portion of the gourmet the point attachment will move with the Entrapped or Entrapping Laterally Movable Grommet, to a degree grater than if the grommet was not able to float or move relative to the primary surface surrounding it, while providing a barrier the flow of fluid, gas, energy (such as light or microwave) or partials (such as dust, sand or sprayed particles).

### BRIEF DESCRIPTION OF THE DRAWINGS

FIG. 1 depicts at the top a cross sectional view and below it an overhead view (perpendicular to the larger flat surface) of one embodiment of the invention that includes a central Entrapped Laterally Movable Grommet entrapped within an enclosure created between the top of the primary martial layer and a disk of material attached to the primary level by a circular bead of adhesive.

FIG. 2 depicts at left an overhead view of the Entrapped Laterally Movable Grommet disk with in addition to its central opening a pattern of raised radial ribs and dots on both the top and bottom side. At the right is shown a cross section view of this embodiment.

FIG. 3 is a cross sectional view of an Entrapped Laterally Movable Grommet within its entrapping enclosure showing how the cable and the Free Floating Grommet passing through it can be displaced to the right of its most central position without causing increased lateral friction or pressure or increasing the opening between the top and bottom of the primary surface to which it is attached.

FIG. 4 shows a variant of the invention wherein the edges of the open hole in both the primary material layer and the underneath entrapping disk of martial are reinforced by the thickening or the application of a conventional simple gourmet in order to provide a reinforced edge to constrain the lateral movement for the cable.

FIG. 5 illustrates another variant of the invention that includes a reinforcement and perpendicular extension of the Entrapped Laterally Movable Grommet circularly surrounding its central hole such that this reinforced section of the Entrapped Laterally Movable Grommet contacts on its outer edge the circular edges of the hole in the primary layer and/or the bottom second entrapping disk of material and on its inner edge contacts the cable when the cable is displaced from its central position by lateral forces.

FIG. 6 illustrates another variant of the invention that includes a “limiting disk” of martial located inside the entrapping enclosure and comprises part of the limiting inner diameter wall within which the Entrapped Laterally Movable Grommet is entrapped, such that lateral displacement of the Entrapped Laterally Movable Grommet is constrained by contact with this “limiting disk”.

FIG. 7 is an illustration of another variant of this invention wherein the central Entrapping Laterally Movable Grommet is composed of two disk layers with a space between them that creates a region of entrapment within which the edges and adjacent area of the primary material layer is entrapped, such that the entire Entrapping Laterally Movable Grommet assembly may move laterally within a larger hole in the primary layer, without exposing a direct opening between the top and bottom sides of the primary layer.

FIG. 8 Illustrates one embodiment of this invention whereby the entrapment within which the Entrapped Laterally Movable Grommet is contained is in part created by the use of a single open flat ring of adhesive material that attaches the bottom layer of entrapping material to the underside of the top primary layer.

FIG. 9 Illustrates another embodiment of this invention whereby the two layer entrapment within which the Entrapped Laterally Movable Grommet is contained is structurally reinforced by the addition of additional material on and proximate to the central openings in the center of these two layers.

FIG. 10 Illustrates another embodiment of this invention whereby the Entrapped Laterally Movable Grommet, is structurally reinforced at its central opening by the addition of a thickened ring like structure through which the movable cable may travel.

FIG. 11 Illustrates another embodiment of this invention whereby the entrapping enclosure is structurally reinforced and augmented by the addition of an open ring of material on the inside of the enclosure where the lateral movement of the middle free floating portion of the grommet may cause the moving portion of the grommet to contact it.

FIG. 12 Illustrates another embodiment of this invention whereby an Entrapping Laterally Movable Grommet creates an entrapment that surrounds an area larger than the hole in the primary layer which it entraps. Rings of adhesive material fasten two larger material rings of predominately flat material that the central Spindle portion of the Entrapped or Entrapping Laterally Movable Grommet, such that the rings of material entrap a portion of the larger martial sheet constrain the gourmet close to the flat plane of the larger material sheet while permitting the entire spindle assembly and the cable or moving object passing though the central hole in the Entrapping Laterally Movable Grommet to move in a relatively free fashion within a limited range of motion largely perpendicular to the primary layer of the larger material sheet.

FIGS. 13, 14, 15, 16 and 17 Illustrates the substitution of a hole in the central portion of the Entrapped or Entrapping Laterally Movable Grommet as otherwise depicted in prior FIGS. 8 through 12, with an anchor point on the top and bottom to which a cable or other object may be attached.

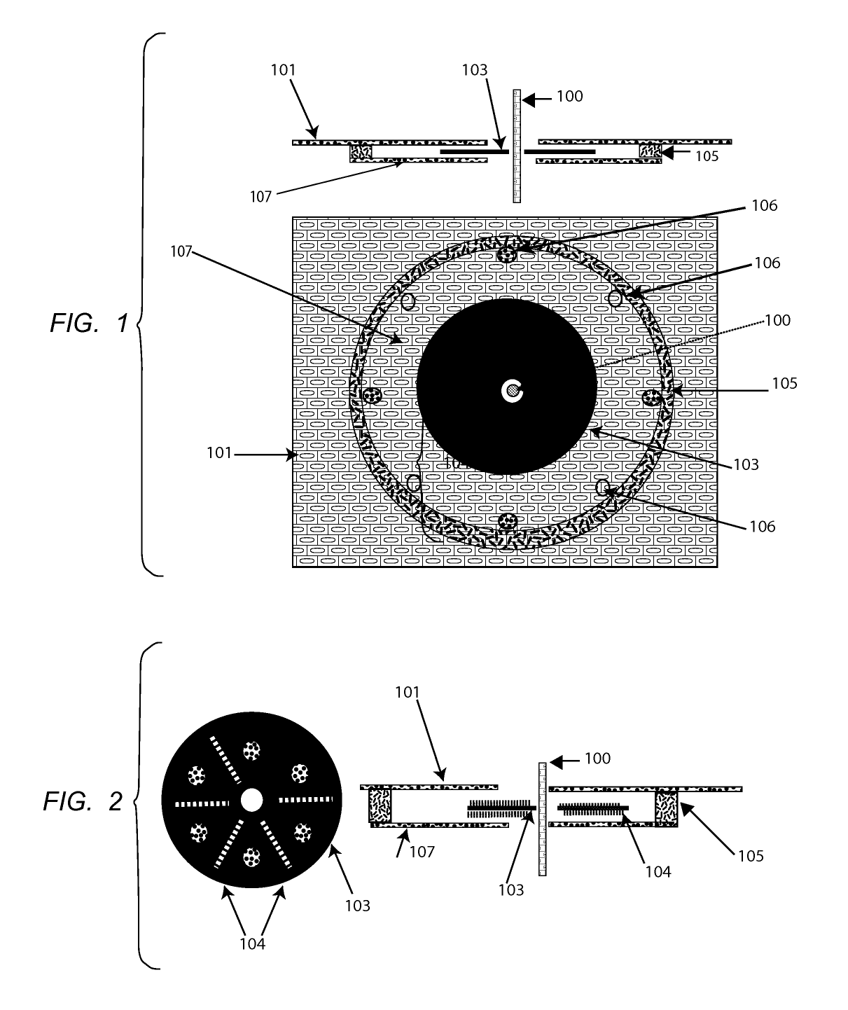

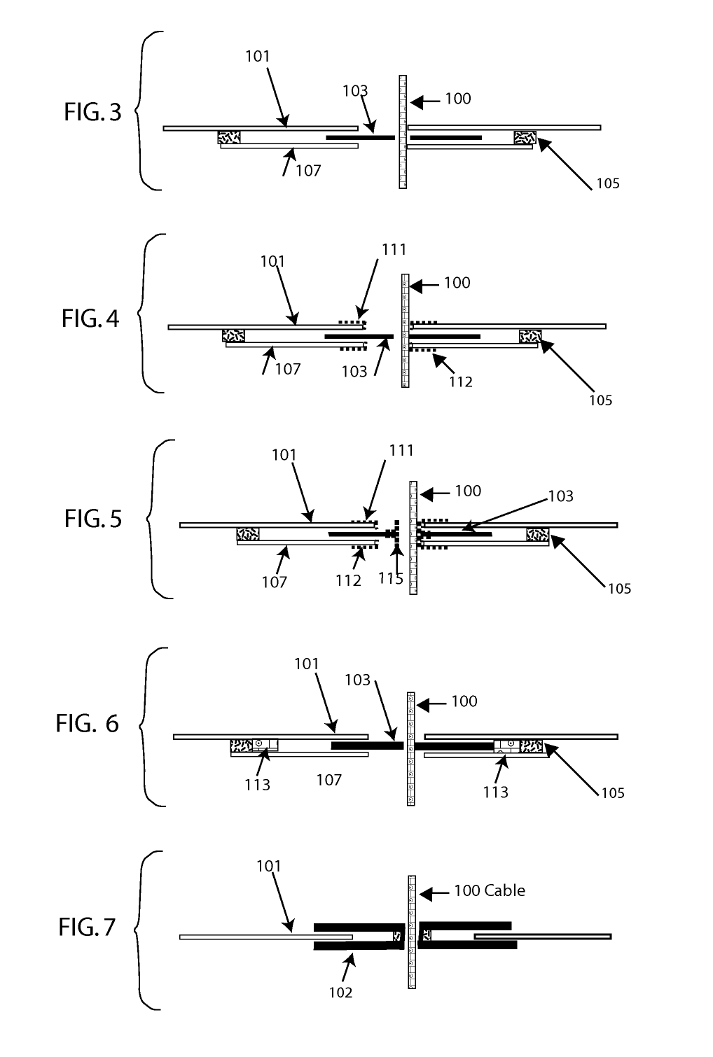

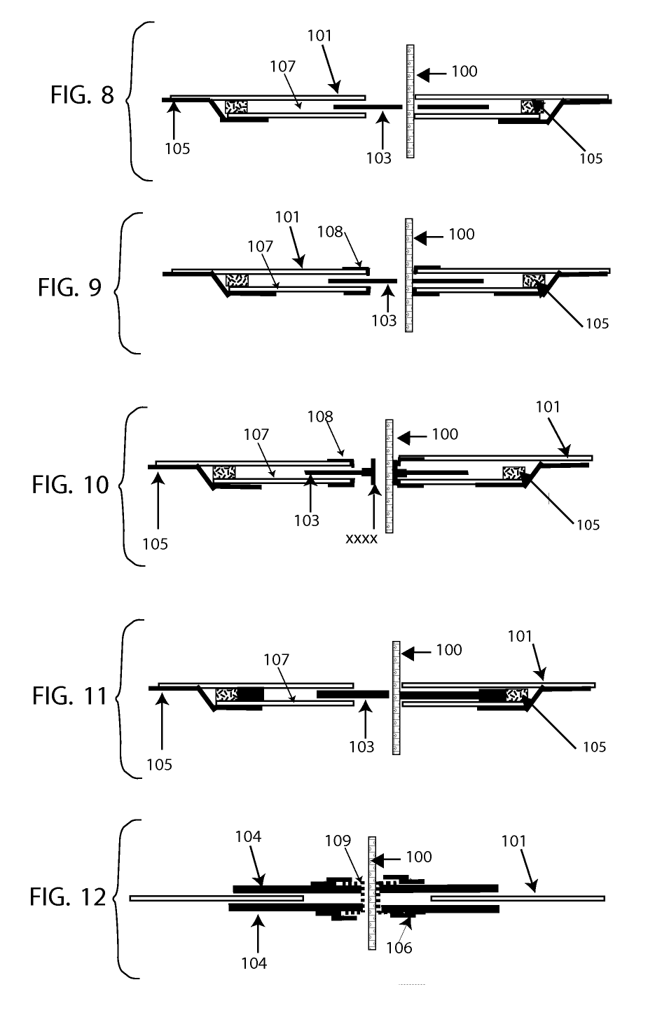

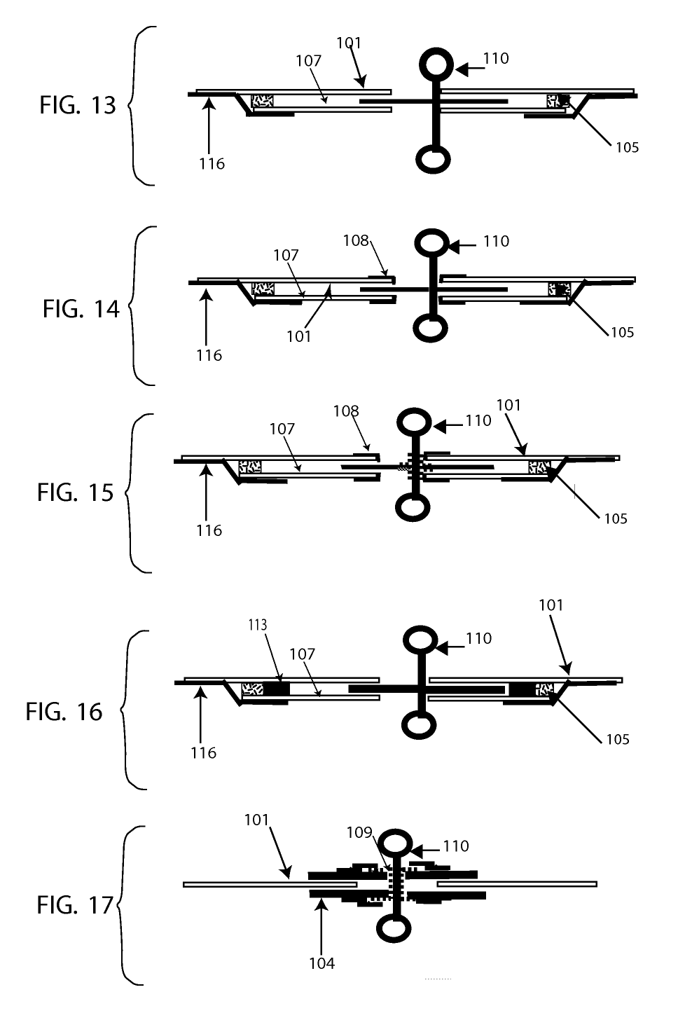

### DETAILED DESCRIPTION

References now should be made to the drawings, in which the same reference numbers are used throughout the different figures to designate the same or similar components. As shown in every cross sectional view the narrow vertically oriented central object designated 100 and/or labeled Cable, represents a cable, cord, rope, or vertically moving object with a small enough cross sectional portion to allow it to pass through a hole in the Entrapped or Entrapping Laterally Movable Grommet. This same vertically oriented object designated 100 and/or labeled Cable is also shown in many of the overhead or top views.

100 Designates a cable passing through the small opening in the Entrapped or Entrapping Laterally Movable Grommet assembly attached to a larger flat surface.

101 Designates the Primary Layer to which Entrapped or Entrapping Laterally Movable Grommet is attached. Examples of this include a flat sheet larger than the Entrapped or Entrapping Laterally Movable Grommet (s) which is (are) affixed to a portion of this primary layer, this could be a tarpaulin, screen, curtain, or other flat section of material used to create a barrio that blocks fully or partially the flow of a fluid, gas, energy (for example light or microwaves), or partials (for example dust or small sprayed solids such as sand).

102 Depicts Entrapping Laterally Movable assembly comprising a central thimble with an opening in its middle that includes top and bottom flat disk shaped layers that entrap a portion of the central flat surface (101).

103 Designates an Entrapped Laterally Movable disk shaped section of the Grommet assembly, which is entrapped within a created enclosure within which it can move laterally and includes at its center a circular hole through which a cable can freely travel in a direction largely perpendicular to the flat surface of the movable disk.

104 Depicts radially oriented lines of raised material on the free floating middle disk shaped layer of material that provides additional spacing between the outer encapsulating surfaces and the middle free floating disk.

105 Designates a circular bead of adhesive or an adhesive washer that attaches the bottom entrapping disk of material to the primary layer of material.

106 Designates a plurality of circular openings in the outer layers of the enclosure entrapping the movable grommet disk, provided to allow drainage or air flow of liquid or glass otherwise entrapped between the layers.

107 Depicts the bottom disk in a three layer assembly that when attached at its outer edge to the primary layer creates the bottom portion of an entrapping enclosure inside of which the flat disk shaped middle section may move laterally.

108 Depicts reinforcements to the edges of the hole in both the primary layer and the bottom disk such that these reinforcements will help sustain the load and friction that the cable moving through them may impose.

109 Depicts a central thimble assemble with a hole trough which the cable may pass, and flat sections to which a top and bottom disk of material can be attached to create a partial enclosure that entraps a portion of the primary layer.

110 Depicts an Anchor Attachment affixed to the laterally movable grommet protruding above and below the plane of the primary flat surface to which the grommet is affixed, to which a cable or other moving object may be attached.

111 Depicts a Reinforcing ring attached to the open edge of the opening in the primary top flat surface comprising one part of the entrapping enclosure.

112 Depicts a Reinforcing Grommet attached to the open edge of the opening in the bottom layer of the disk of material comprising the bottom part of the entrapping enclosure.

113 Depicts a ring of material inside near the peripheral edge of the entrapping enclosure that mechanically constrains the movement of the entrapped laterally movable disk.

115 Depicts a reinforcement to the central opening in the lateral movable disk (Item 103).

116 Depicts a disk of flexible material that can attach the bottom layer (107) to the top flat surface (101).

### Alternative Embodiments

While the embodiment described herein illustrates how the claimed elements and claimed combinations of features may be achieved by alternative variations

### CONCLUSION

In the foregoing specification, the invention has been described with reference to specific embodiments thereof. It will, however, be evident that various modifications and changes may be made thereto without departing from the broader spirit and scope of the invention. The specification and drawings are, accordingly, to be regarded in an illustrative rather than a restrictive sense.

1. A new grommet like device that can be used to allow an object to freely move both perpendicularly and parallel to a larger flat surface to which this device is attached, where this device is comprised of at least three largely flat parallel layers, one of which is a free floating middle layer entrapped within an enclosing structure composed of at least two flat surfaces that are largely parallel to both the larger flat surface and the entrapped freely movable middle section, wherein the movable middle section has a central opening the same size or slightly larger than the cross sectional area of an object that may freely move through that opening perpendicular to the flat surface, and such that the moving object can also move parallel to the flat surfaces by causing the floating grommet to move within its entrapped enclosure, and central located openings in the outer layers are provided to allow the moving object passing through the movable free floating surface; to move further in a direction largely parallel to the surface to which it is attached than the small opening in the center of the grommet would otherwise allow without substantial pressure and friction being caused by such movement, and without causing a lateral movement of the larger surface, while the free floating surface provides a barrier to the linear flow from one side of the larger flat surface to the other of fluid, gas, radiant and vibrational energy through the openings in the outer surfaces which the movable middle surface of this grommet like device blocks.

2. A device as provided for in claim 1 wherein the middle layer instead of having a centrally located hole has a centrally located anchor pint to which a moving object may be attached and travel freely in directions parallel to the larger flat surface to which it is attached without causing movement of the larger surface.

3. The device and method of claims 1 and 2 wherein one of the outer entrapping flat surfaces is comprised of a portion of the larger flat surface to which this device is attached.

4. The device and method of claims 1 and 2, wherein the entrapping enclosure is created by a larger flat sheet of material that has an open hole that is completely surrounded by a smaller flat sheet of material which is attached only at its outer periphery, such that the opening in the larger sheet is completely surrounded by the attached smaller sheet, and the attached smaller sheet has an open hole smaller than the hole in the larger sheet.

5. The device and method of claims 1 and 2 wherein the Entrapped Laterally Movable Grommet has holes and/or raised lines or bumps to provide controlled air flow to facilitate drainage and evaporation of a liquid that may enter the entrapment, and to reduce the friction of movable component within its entrapping enclosure.

6. The device in claims 1 and 2 wherein the outer flat sections of the entrapping enclosure have small holes or opening to provide increased air flow to facilitate drying if the enclosure entraps a liquid and to reduce the friction of movement of the free floating middle surface entrapping within the enclosure.

7. The combination of claim 5 and 6 such that the holes are arranged so they do not align with each other to provide a contiguous opening through which a gas, fluid, and radiant or vibrational energy might flow in a straight line from one side of the primary layer to the other.

8. The device in claims 1 and 2, wherein the Entrapped or Entrapping Laterally Movable Grommet's inner opening is reinforced to prevent tearing and reduce friction.

9. The device in claims 1 and 2, wherein the disk of material comprising one of the outer surfaces is attached to the primary flat sheet at its outer edge with a circular adhesive bead at or near its outer edge.

10. The device in claims 1 and 2 wherein the disk of material comprising one of the outer surfaces is attached to the primary flat sheet at its outer edge, by a ring of double stick adhesive material with adhesive top and bottom surfaces.

11. The device in claims 1 and 2 wherein the inner edges of the central opening in the primary sheet are reinforced to prevent abrasion, tearing and to reduce friction with an object moved through this opening.

12. The device in claims 1 and 2 wherein a washer of spacer is placed between the primary sheet and the circular disk to provide an expanded volume of space in which the entrapped gourmet may travel with reduced friction from the enclosures inner top and bottom surfaces contacting the movable entrapped grommet.

13. A new grommet like device that can be used to allow a an object to freely move both perpendicularly and parallel to a larger flat surface to which this device is attached, comprised of at least three largely flat parallel layers, one of which is a middle layer comprised of an entrapped portion of the larger flat surface with a central opening and two outer surfaces which are joined at their centers to form free floating parallel layers entrapping a portion of the middle layer, wherein the movable outer layers are larger that a centrally located opening in the middle layer that the outer layers surround, and the joined central portion of the two outer layers has a central opening the same size or slightly larger than the cross sectional area of an object that may freely move through that opening perpendicular to the flat surface, and such that the moving object can also move parallel to the flat surfaces by causing the floating outer layers to move further in a direction largely parallel to the surface to which it is attached than the small opening in the center of the joined outer layers would otherwise allow without substantial pressure and friction being caused by such movement, and without causing a lateral movement of the larger surface, while providing a barrier to the linear flow of fluid, gas, radiant and vibrational energy from on side of the larger flat surface to the other.

14. A device as provided in claim 13, wherein the outer two layers instead of having a centrally located hole at their centers where they are joined together has an centrally located anchor pint to which a moving object may be attached and travel freely in directions parallel to the larger flat surface to which it is attached without causing movement of the larger surface.

15. The device as provide in claims 13 and 14, wherein the Entrapping Laterally Movable Grommet has holes to provide increased air flow to facilitate drying if the enclosure entraps a liquid and to reduce the friction of its movement within its entrapping enclosure.

16. The device as provide in claims 13 and 14, wherein the top or bottom sections of the entrapping enclosure have small holes or opening to provide increased air flow to facilitate drying if it entraps a liquid a liquid and to reduce the friction of its movement within its entrapping enclosure.

17. The device as provide in claims 15 and 16, wherein that the holes are arranged such that they do not allow an alignment of openings through which a gas, fluid, or energy might flow in a straight line from one side of the primary layer to the other.

18. The device and method of claim 12, wherein a central thimble shaped structure with a central hole and larger flat parallel top and bottom surfaces are attached to a top and bottom to create an enclosure that entraps a portion of the larger flat surface of which the Entrapped or Entrapping Laterally Movable Grommet is a part or attached to, such that the entrapped section of material includes a hole larger than the hole passing through the grommet such that this larger hole permits increased travel of the cable in directions largely pare ell to the larger surface and wherein the floating grommet has a diameter in one or more of its layers that is sufficiently larger than the hole in the entrapped central surface layer, to cover the hole in the larger entrapped layer within the full range of travel permitted by the displacing of the floating grommet by movement of the cable in directions largely parallel to the larger surface, and were this lateral movement is restricted by movement of the cable within the confines of the larger hole such that the floating grommet in combination with its enraged position or in combination with the material it entraps, substantially impends the movement of a gas, fluid, or energy from one side of the larger flat surface to the other side.
